(19) United States
(12) Patent Application Publication
(10) Pub. No.: US 2005/0091878 A1
(43) Pub. Date: May 5, 2005

(54) Drier and method of controlling drying for the same

(76) Inventors: Jae Suk Yang, Changwon-shi (KR); Sang Doo Kim, Changwon-shi (KR); Seong Hae Jeong, Changwon-shi (KR)

Correspondence Address: Song K. Jung;MCKENNA LONG & ALDRIDGE LLP, 1900 K Street, N.W., Washington, DC, 20006, US

(21) Appl. No.: 11/002,415

(22) Filed: Dec. 3, 2004

Related U.S. Application Data
(62) Division of application No. 10/451,340, filed on Jun. 23, 2003.

(30) Foreign Application Priority Data
Oct. 25, 2001 (KR) 2001/66076
Oct. 25, 2001 (KR) 2001/66077

(51) Int. Cl. F26B 19/00

(52) U.S. Cl. 34/549

(57) ABSTRACT

The present invention relates to a drier, more particularly a drier and a method of controlling drying for the same for prohibiting a heater form operating with an error and controlling a quantity of a power needed drying. For the process, the present invention is to provide a device (320) for checking whether a blower (31) is normally operated or not, a plurality of heaters, and a plurality of switching devices for controlling the heaters.

### TECHNICAL FIELD

The present invention relates to a drier and drying control method for the same, and more particularly to a drier and drying control method, which is capable of preventing operation of the heater due to malfunction of a drier and controlling an amount of an electric energy necessary for a drying operation.

### BACKGROUND ART

FIG. 1 is an exploded perspective view of main components of a conventional drier. Referring to FIG. 1, a drum 1 is mounted inside a cabinet (not shown) defining the outer shell of the driver. The drum 1 is shaped in a cylinder, of which both ends are opened. The drum 1 has a belt groove 2 formed along the central portion of the outer circumference and along which a belt (not shown) driven by an additional driving source is wound. A drying chamber 5 in which drying is performed is formed inside the drum 1. A plurality of baffles 6 are formed inside the drying chamber. When the drum 1 is rotated, the baffles 6 functions to turn over objects to be dried.

Front and rear heads 7 and 9 are installed on front and rear ends of the drum 1, respectively. Here, the front and rear heads 7 and 9 cover the opened portions of the drum 1 to thereby define the drying chamber 5, and function to support the front and rear ends of the drum 1. At this time, sealants 10 for preventing leakage are insertingly equipped between the front head 7 and the drum 1 rotating relative to the other as well as between the rear head 9 and the drum 1 rotating relative to the other. Also, a plurality of rollers (not shown) for supporting the drum 1 are installed at positions corresponding to the front and rear ends of the drum 1.

The front head 7 has communication holes 8 for communicating the inside of the drying chamber 5 with the outside thereof. The communication holes 8 are selectively closed and opened by a door (not shown).

An air feed duct 12 is disposed at the rear head 9 and communicates with the inside of the drying chamber 5. The air feed duct 12 acts as a passage for feeding air, more specifically hot air, into the drying chamber 5.

An outlet assembly 13 is mounted on one side of the front head 7, which corresponds to a lower portion of the communication holes 8 of the front head 7. Air is exhausted from the drying chamber 5 via the outlet assembly 13. A lint filter 14 is equipped in the outlet assembly 13. The lint filter 14 functions to filter foreign particles (e.g., seam or dust) mixed in the exhausted air.

A lint duct 15 is installed to communicate with the outlet assembly 12 and the lint filter 14 is disposed to an inside of the lint duct 15. A blower 17 is connected to the lint duct 15 and exhausts air out of the drying chamber 5 via the lint duct 15. The blower 17 is installed inside a blower housing 18. The blower housing 18 has one end communicating with the lint duct 15 and the other end connected to an exhaust pipe 19. Therefore, air which is exhausted from the drying chamber 5 and passes through the lint duct 15 is discharged to the outer environment via the exhaust pipe 19 by a force of the blower 17.

Meanwhile, a hot air duct 20 is connected to the air feed duct 12. The hot air duct 20 functions to supply hot air used for the drying operation within the drying chamber 5. For this, the hot air duct 20 includes a construction for generating a thermal energy so as to heat air.

In other words, a gas nozzle 22 is installed at an entrance of the hot air duct 20. The gas nozzle 22 functions to inject the supplied gas. The gas nozzle 22 includes a valve (not shown) for controlling the supply of the gas. A reference numeral 23 denotes a gas pipe.

A mixture pipe 24 is formed elongatedly from the entrance of the hot air duct 20 to the inside thereof. The mixture pipe 24 mixes the gas injected from the gas nozzle 22 with a primary air. Here, an entrance of the mixture pipe 24 is disposed at a position corresponding to the gas nozzle 22. In the inside of the mixture pipe 24, the gas injected from the gas nozzle 22 is mixed with the external gas (i.e., the primary gas) which flows inwardly through the entrance of the mixture pipe 24. A spark plug 26 is mounted on the front end of the mixture pipe 24 and generates a spark for ignition. Hereinafter, the construction for generating the thermal energy is referred to as a heater.

A construction for controlling the drier constructed as above will be described below. FIG. 2 illustrates a construction of the conventional drier.

The conventional drier is configured to perform the drying operation under a control of a microcomputer 100. The conventional drier includes: a drive unit 120 electrically controlled within the drier, a group of sensors 110 for detecting electric signals; and a microcomputer 100 for receiving detected signals from the sensors 110, generating control signals according to the detected signals, and providing the control signal to the drive unit 120 and the sensors 110. The group of sensors 110 include: a key input unit 103 for providing the microcomputer 100 with a power supply signal, a drying operation signal and drying conditions, which are selectively inputted by a user, an electrode sensor signal conversion unit 106 for converting a signal detected by the electrode sensor (not shown) into a signal readable by the microcomputer 100 and providing the converted signal to he microcomputer 100 so as to detect the current dryness of laundry; a first temperature sensor signal conversion unit 109 for converting a signal detected by the first temperature sensor (not shown) into a signal readable by the microcomputer 100 and providing the converted signal to the microcomputer 100 so as to detect the temperature of hot air fed into the drum 1; a second temperature sensor signal conversion unit 112 for converting a signal detected by the second temperature sensor (not shown) into a signal readable by the microcomputer 100 and providing the converted signal into the microcomputer 100 so as to detect the temperature of hot air exhausted from the drum 1; and a door detection unit 115 for detecting the opening of a door while laundry is being dried, converting the detection result into a signal readable by the microcomputer 100 and providing the converted signal to the microcomputer 100.

The drive unit 120 includes: a drum motor drive unit 118 for driving a drum motor (not shown) which generates a driving force for rotating the drum 1; a blower motor drive unit 121 for driving a blower motor (not shown) which generates a driving force for rotating the blower 17; and a heater drive unit 124 for supplying a heat source for drying laundry via the hot air duct 20.

As described above, respective components of the drive unit 120 are controlled by the microcomputer 100.

Hereinafter, there will be described an operation of the conventional drier constructed as above.

A user primarily loads laundry into the drying chamber 5 of the drum 1 so as to dry laundry. The user closes a door and selects a dry mode from the key input unit 103. A selection signal corresponding to the dry mode is inputted into the microcomputer 100. The microcomputer 100 recognizes the dry mode of the drier in response to the selection signal. If the user selects the dry mode, the microcomputer 100 drives the drum motor drive unit 118. As the drum motor drive unit 118 is driven, the belt wounded around the belt groove 2 is rotated by an additional driving source and accordingly the drum 1 is rotated.

The microcomputer 100 provides the control signal to the blower motor drive unit 121 to thereby drive the blower motor. If the blower motor is driven, the blower 17 operates. The blower 17 exhausts air out of the drying chamber 5 via the lint duct 15. If air in the drying chamber 5 is exhausted, an external air is introduced into the drying chamber 5 via the air feed duct 12.

Meanwhile, the microcomputer 100 drives the heater drive unit 124. The heater drive unit 124 heats the introduced air so as to increase a temperature of the introduced air when the introduced air passes through the hot air duct 20. With the control of the heater drive unit 124, the microcomputer 100 drives the valve so as to control an amount of the gas supplied via the gas nozzle 22, and controls an ignition operation of the spark plug 26. As the microcomputer 100 controls the valve and the spark plug 26, the temperature of air introduced into the drying chamber 5 is substantially controlled. In more detail, if air is injected into the mixture pipe 24 via the gas nozzle 22, the injected gas is ignited by the spark plug 26 and then burned out. At this time, a thermal energy is generated while the air is being burned out. The thermal energy heats air which is being introduced into the drying chamber 5, so that the hot air is generated.

The hot air is provided to the drying chamber 5 disposed inside the drum 1 via the air feed duct 12. The hot air absorbs moisture contained in laundry and then is exhausted out of the drying chamber 15 via the outlet assembly 13. The exhaust of air is carried out by a suction force of the blower 17. Air exhausted from the outlet assembly 13 passes through the lint filter 14 and thus foreign particles such as dust or seam are filtered.

When laundry is dried in such a hot air circulation method, the microcomputer 100 determines the dryness of laundry based on the detection value of the electrode sensor signal conversion unit 106. In addition, the dryness of laundry is finally determined based on temperatures of hot air introduced/exhausted into/from the drum 1, which are detected by the first and second temperature sensor signal conversion units 109 and 112, respectively, and the drying operation is controlled.

However, the conventional drier constructed as above has following problems.

The conventional drier accomplishes air circulation in the inside/outside of the drum 1 using the suction force generated by the driving of the blower 17, and controls the supply of hot air into the drum 1. Accordingly, the blower 17 should be driven in a state that the heater generating the thermal energy is driven.

If the blower 17 does not operate normally, although the temperature of the inside of the drum 1 is continuously increased due to the thermal energy generated by the heater, the air circulation between the inside and the outside of the drum 1 is not accomplished. Accordingly, due to the continuous increase of the temperature in the inside of the drum 1, laundry which is being dried may be damaged and a fire may be caused in some parts. In addition, as coils contained in the heater is continuously generating a high heat, a lifetime of the heater may be shortened.

Meanwhile, when it is determined that the heater needs to be driven at the dry mode of the drier, the microcomputer 100 controls the operation of the heater through the heater drive unit 124. At that time, the conventional drier does not include a protective construction which can allow the microcomputer 100 to determine whether or not the blower 17 operates normally. In the conventional drier, after a predetermined time since the microcomputer 100 drives the blower motor, the microcomputer 100 controls the heater to operate.

Accordingly, the conventional drier does not have the protective construction which can stop the operation of the heater when there occurs a malfunction of the blower 17. Consequently, the conventional drier has a problem that a fire may break out due to malfunctions of some parts. Also, the reliability of drier is degraded due to these problems. Further, a user's safety may be threatened and a fatal defective may be caused to the drier.

Meanwhile, FIGS. 3a and 3b are views showing a driving control of the heater by the microcomputer 100.

As shown, the control of the heater is accomplished using a relay and a triac. However, that control method has following problems.

Referring to FIG. 3a, relays RY1 and RY2 are serially connected to heaters H1 and H2, and one pair of relay and heater is connected in parallel to another pair. Therefore, although multi-stage operations of the heater can be controlled under an on/off control of the relays, it is impossible to variably control an output power of the heater.

In addition, referring to FIG. 3b, the control of the heater can be accomplished using power devices, such as a triac T1, a silicon controlled rectifier (SCR) and a solid-state relay (SSR). This construction can variably control the output power of the heater H3. However, if the capacity of the heater is large, a cooling fan must be used to solve a heat generation of the power devices.

In other words, in the conventional drier, it is impossible to variably control the output power of the heater in case where the heater is controlled using the relay. In case where the heater is controlled using the triac, there is a constructive problem, such as an employment of the cooling fan for solving the heat generation. In that case, there is also a problem that a manufacturing cost is increased

### DISCLOSURE OF THE INVENTION

Accordingly, the present invention is directed to a drier and drying control method for the same that substantially obviate one or more of the problems due to limitations and disadvantages of the related art.

An object of the present invention is to provide a drier and drying control method for the same, which is capable of obtaining a stable operation by allowing a heater to be operated according to driving states of a blower.

Another object of the present invention is to provide a drier and drying control method for the same, which is capable of varying an output power of a heater.

Additional features and advantages of the invention will be set forth in the description which follows, and in part win be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, there is provided a drier comprising: a drum rotatably mounted on the drier, for loading objects to be dried thereinto; a blower for circulating air inside the drum; a heating means for heating air introduced into the drum according to an operation of the blower, and an operation detection means for detecting a rotation speed of the blower and controlling the heating means according to the detection result

To further achieve these and other advantages and in accordance with the purpose of the present invention, there is provided a drier comprising: a drum rotatably mounted on the drier, for loading objects to be dried thereinto; a heating means for heating air introduced into the drum; and a control means for determining an amount of power to be supplied to the heating means according to the objects to be dried and controlling the heating means according to the determination result, wherein the heating means includes: at least two heaters independently generating heat according to a control of the control means; and drive units for driving the heaters.

To further achieve these and other advantages and in accordance with the purpose of the present invention, there is provided a drying control method of a drier, in which the drier includes: a drum rotatably mounted on the drier, for loading objects to be dried thereinto; and a blower for circulating air inside the drum. The drying control method comprises the steps of: rotating the blower at a dry mode; detecting a rotation speed of the blower; and controlling a heating of air introduced into the drum according to the detection result.

To further achieve these and other advantages and in accordance with the purpose of the present invention, there is provided a drying control method of a drier, in which the drier includes: a drum rotatably mounted on the drier, for loading objects to be dried thereinto; and a heating means for heating air introduced into the drum. The drying control method comprises the steps of: determining an amount of an electric energy according to the objects to be dried; and independently controlling a plurality of heaters according to the determination result, the plurality of heaters being contained in the heating means.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together wit the description serve to explain the principles of the invention.

In the drawings:

FIG. 1 is an exploded perspective view of main components of a conventional drier;

FIG. 2 illustrates a construction of the conventional drier;

FIGS. 3a and 3b illustrate a construction of the conventional heater;

FIG. 4 is a side sectional view of a drier in accordance with the present invention;

FIG. 5 is a plan view of the drier in accordance with the present invention;

FIG. 6 illustrates a construction of a drier in accordance with an embodiment of the present invention;

FIG. 7 illustrates the normal operation detection unit of the blower motor shown in FIG. 6;

FIG. 8 is a flowchart explaining an operational process of the drier in accordance with the present invention;

FIG. 9 illustrates a construction of a drier in accordance with another embodiment of the present invention;

FIG. 10 illustrates a construction of the heater of the present invention; and

FIG. 11 is a graph showing a characteristic of the heater of the present invention.

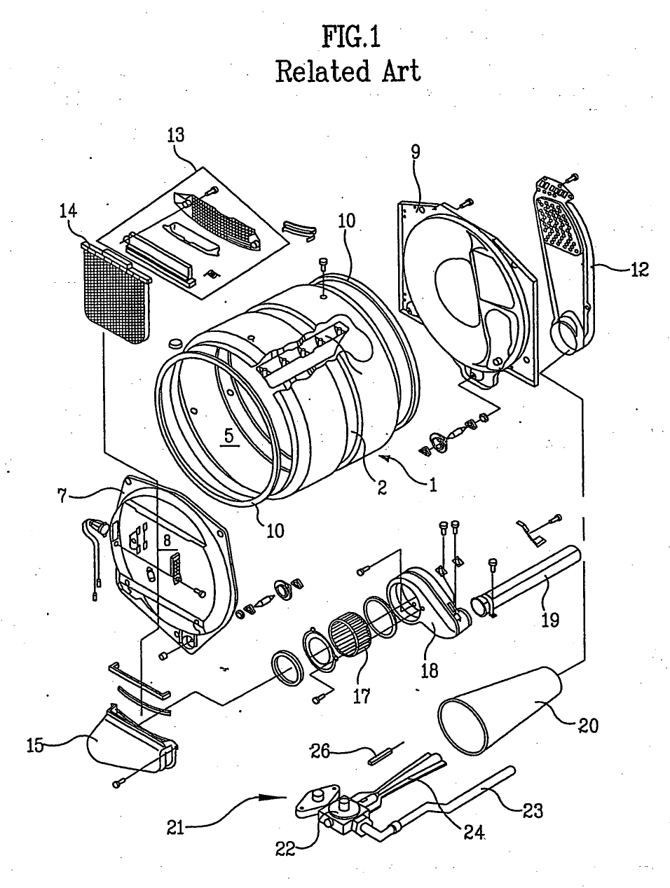

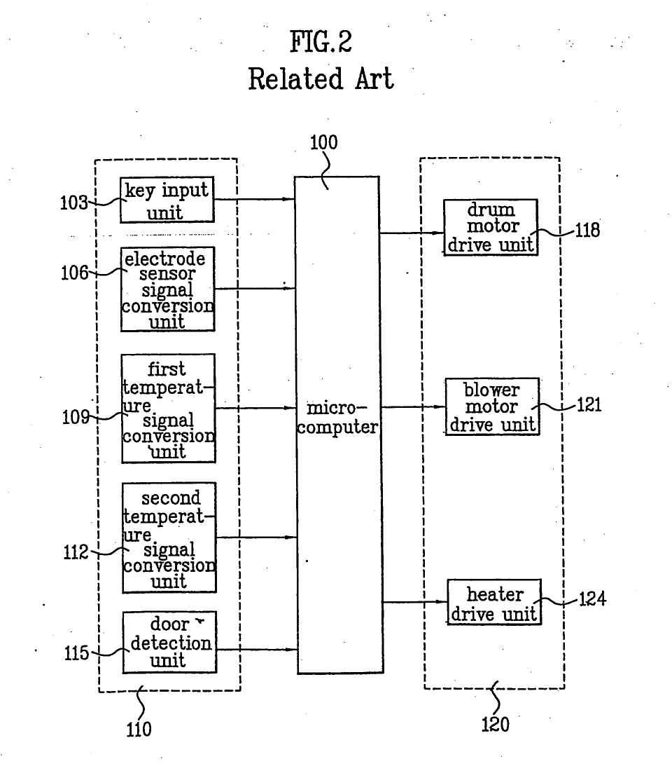

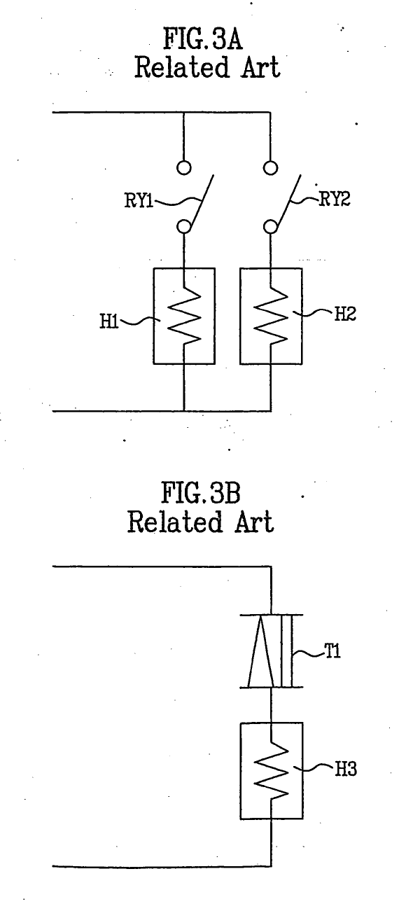

### EST MODE FOR CARRYING OUT THE INVENTION

Reference will now be made in detail to the preferred embodiments of the present invention, examples of which are illustrated in the accompanying drawings.

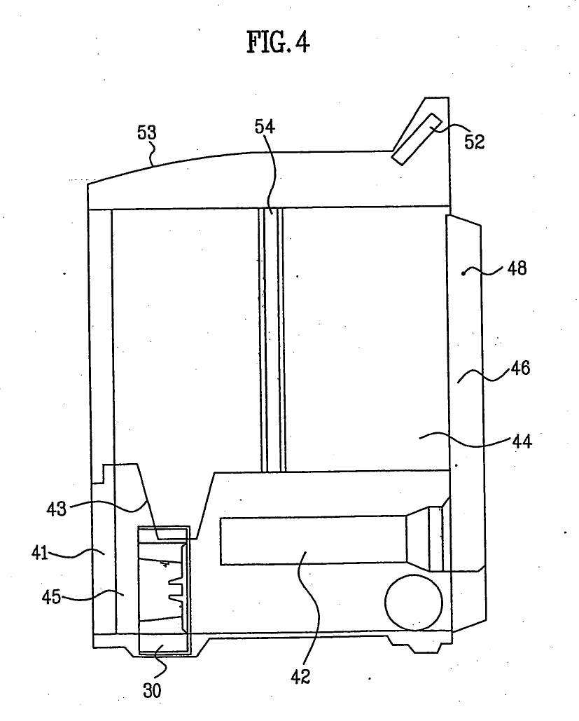

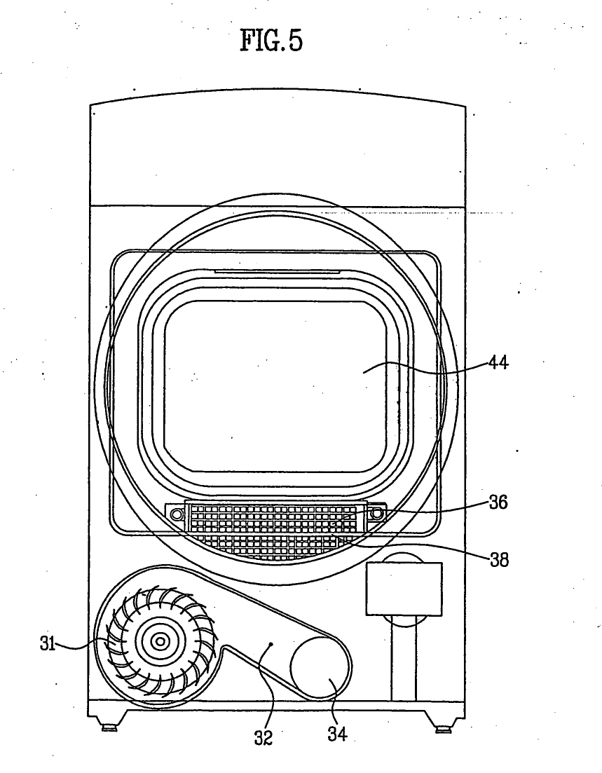

FIGS. 4 and 5 illustrate a construction of a drier in accordance with the present invention.

Referring to FIGS. 4 and 5, the drier of the present invention has an outer case 53 defining an outer shell thereof. A front plate 41 is connected to a leading end of the outer case 53 so as to form a front face of the drier. A drum 44 is rotatably installed inside the outer case 53 such that laundry is loaded into and dried in the drum 44. The drum 44 is rotated by a drum drive belt 54 which surrounds an outer surface of the drum 44.

An exhaust hole 43 is formed to correspond to an inner surface of a front plate 41 and be opened toward the inside of the drum 44. The exhaust hole 43 functions to exhaust air out of the drum 44. A lint filter 36 is disposed at an entrance of the exhaust hole 43 so as to remove foreign particles contained in air.

At a portion of the exhaust hole 43, an electrode sensor 38 is disposed for detecting the dryness of laundry within the drum 44 while the laundry is dried. The electrode sensor 38 detects the dryness of laundry based upon a difference of voltages applied to both end terminals of the electrode when the laundry is in contact with the electrode 38. The electrode sensor 38 provides a microprocessor 100 with a detection signal in the form of a voltage signal. An exhaust passage 45 is placed inside the front plate 41 so as to be connected with the exhaust hole 43. A blower assembly 30 is installed so as to communicate with the exhaust passage 45. The exhaust passage 45 includes a second temperature sensor 32 for detecting the temperature of air which is exhausted out of the drum 44.

The blower assembly 30 is connected to an exhaust duct 34 for discharging air which is exhausted via the exhaust passage 45 out of the drier. The blower assembly 30 includes a blower 31 which sucks and circulates air into/in the drum 44 to introduce heat of a heater 42, and discharges moisture from the laundry via the exhaust hole 43. The blower 31 employs a velocity-variable type.

A feed duct 46 for feeding air into the drum 44 is disposed at a portion corresponding to a lower portion of the drum 44 within the outer case 53. The feed duct 46 feeds air into the drum 44 via a rear portion of the drum 44. A heater 42 is disposed at a portion of the feed duct 46. A temperature sensor 48 for detecting the temperature of the air sucked into the drum 44 is disposed in another portion of the feed duct 46.

A mainboard 52 is disposed in a portion within the outer case 53 so as to electrically control the operation of the drier. The mainboard 52 includes a microcomputer 200 for generally controlling the drier, a drive unit 220 for driving components which should be electrically controlled within the drier, and a group of sensors 210 for detecting electric signals so as to judge the operational state of the drier.

The group of sensors 210 include: a key input unit 201 for providing the microcomputer 200 with a power supply signal, a drying operation signal and drying conditions, which are selectively inputted by a user, an electrode sensor signal conversion unit 202 for converting a signal detected by the electrode sensor 38 into a signal readable by the microcomputer 200 and providing the converted signal to the microcomputer 200 so as to detect the current dryness of laundry; a first temperature sensor signal conversion unit 203 for converting a signal detected by the first temperature sensor 48 into a signal readable by the microcomputer 200 and providing the converted signal to the microcomputer 200 so as to detect the temperature of hot air fed into the drum 44; a second temperature sensor signal conversion unit 204 for converting a signal detected by the second temperature sensor 32 into a signal readable by the microcomputer 200 and providing the converted signal into the microcomputer 200 so as to detect the temperature of hot air exhausted from the drum 44; and a door detection unit 205 for detecting the opening of a door while laundry is being dried, converting a result of the detection into a signal readable by the microcomputer 200 and providing the converted signal to the microcomputer 200.

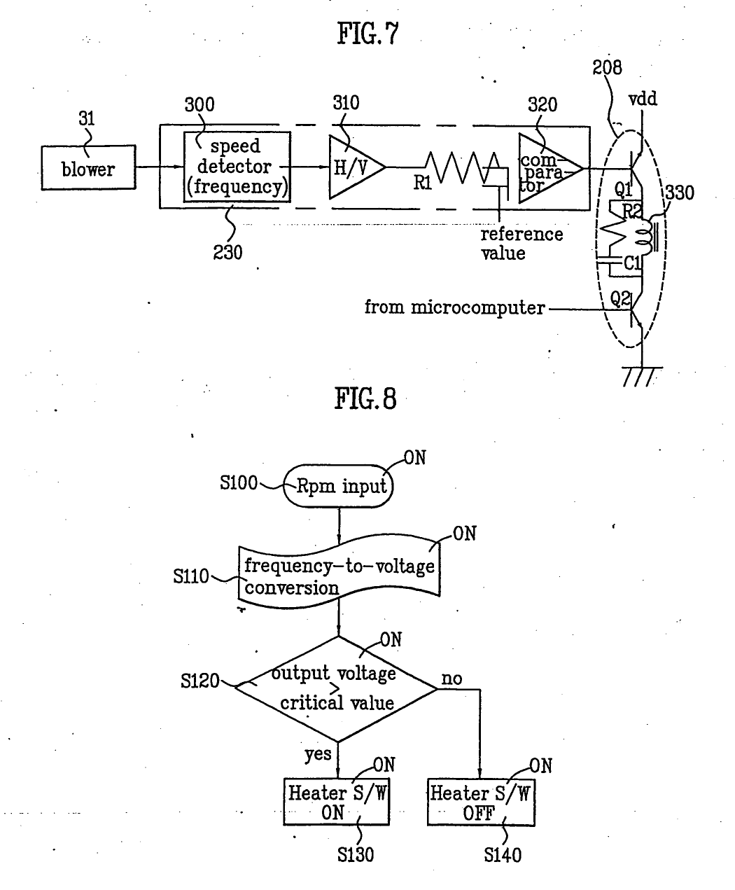

The drive unit 220 includes: a drum motor drive unit 206 for driving a drum motor (not shown) which generates a driving force for rotating the drum 44; a blower motor drive unit 207 for generating a driving force for rotating the blower 31; a heater drive unit 208 for supplying a heat source for drying laundry via the feed duct 46; and a normal operation detection unit 230 for detecting a rotation speed of the blower 31 to determine whether or not the blower 31 operates normally and protecting the operation of the heater 42. The normal operation detection unit 230 is illustrated in detail in FIG. 7.

The normal operation detection unit 230 includes: a speed detector 300 for generating a frequency signal corresponding to a speed of the blower 31 so as to detect a speed (RPM) of the blower 31; a frequency-to-voltage converter 310 for generating a voltage signal proportional to the frequency signal which is an output of the speed detector 300; and a comparator 320 for comparing the voltage signal outputted from the frequency-to-voltage converter 310 with a critical value so as to determine whether or not the blower 31 operates normally.

The heater drive unit 208 is controlled according to the value outputted from the comparator 320 based upon the comparison result and the control value provided from the microcomputer 200. The speed detector 300 is configured to generate the frequency signal corresponding to the rotation speed of the blower 31 by using, for example, a photo-encoder.

The frequency signal generated by the speed detector 300 is inputted into the frequency-to-voltage converter 310. The frequency-to-voltage converter 310 outputs a voltage value proportional to the inputted frequency signal. In this manner, the voltage corresponding to the rotation speed of the blower 31 is detected.

In the comparator 320, a value which is detectable when the blower 31 operates normally is used as the critical value.

If the comparator 320 outputs the determination value of whether or not the blower 31 operates normally, the heater drive unit 208 is controlled according to the determination value.

In other words, as shown in FIG. 7, the heater drive unit 208 includes a PNP transistor Q1 performing a switching operation in response to the output of the normal operation detection unit 230, an NPN transistor Q2 controlled by the microcomputer 200, and a relay 330 for driving the heater 42. The PNP transistor Q1, the relay 330 and the NPN transistor Q2 are connected in series.

Only when the two switching devices Q1 and Q2 are all turned on, a current is applied to the relay 330 and then the heater 42 is driven.

Hereinafter, there will be described an operational process of the drier constructed as above.

FIG. 8 is a flowchart for explaining the stable driving operation of the heater in the drier of the present invention.

Referring to FIG. 8, a user primarily loads laundry into the drum 44 so as to dry laundry. The user closes a door and selects a dry mode from the key input unit 201. A selection signal corresponding to the dry mode is inputted into the microcomputer 200. The microcomputer 200 recognizes the dry mode of the drier in response to the selection signal and outputs a drum drive signal to the drum motor drive unit 206. As the drum motor (not shown) is actuated, the drum drive belt 54 is rotated and accordingly the drum 44 is rotated.

The microcomputer 200 outputs a blower motor drive signal to the blower motor drive unit 207. The blower assembly 30 is operated in response to the blower motor drive signal and the operation of the blower motor assembly 30 drives the blower 31. As the blower 31 is driven, air in the drum 44 is exhausted to the exhaust duct 34 via the lint filter 36.

Before and after the time point when air in the drum 44 is exhausted, the microcomputer 200 outputs a heater drive signal to the heater drive unit 208. The NPN transistor Q2 shown in FIG. 7 is switched to a turned-on state in response to the heater drive signal. At this time, the PNP transistor Q1 of the heater drive unit 208 is maintained in a turned-off state. Accordingly, in spite of the heater drive signal outputted from the microcomputer 200, the heater drive unit 208 does not operate normally.

Meanwhile, if the blower 31 starts to be driven, the speed detector 300 detects the frequency signal corresponding to the rotation speed of the blower 31 (S100). The frequency-to-voltage converter 310 converts the detected frequency signal into the voltage signal corresponding to the detected frequency signal (S110). The comparator 320 compares the voltage signal with the critical value (S120). If the voltage signal is larger than the critical value, the comparator 320 outputs a low signal to thereby turn on the PNP transistor Q1 (S130). As the PNP transistor Q1 is turned on and the microcomputer 200 provides the heater drive signal to the NPN transistor Q2, there is formed a current path extending from a power supply voltage Vdd to the transistors Q1 and Q2 and the relay 330. Accordingly, the heater 42 operates normally. Meanwhile, if the voltage signal is not larger than the critical value, the comparator 320 outputs a high signal to thereby maintain the NPN transistor Q2 in a turned-off state (S140). Accordingly, although the microcomputer 200 provides the heater drive signal to the NPN transistor Q2 of the heater drive unit 208, a current path extending from the power supply voltage Vdd to the relay 330 is cut off. As a result, the heater 42 does not operate normally. In other words, although the comparator 320 outputs the heater drive signal when the rotation speed of the blower 31 is increased above a predetermined level, the comparator 320 outputs a signal cutting off the driving of the heater 42 when the rotation speed of the blower 31 is below the predetermined level. With the formation of the current path extending from the power supply voltage Vdd to the transistors Q1 and Q2 and the relay 330, if the heater drive unit 208 operates normally, the heater 42 is driven and accordingly a thermal energy necessary for the drying operation is generated.

When the blower 31 exhausts air out of the drum 44, an external air is sucked into the drum 44 via the feed duct 46. Due to a heat generation of the heater 42 at an entrance of the feed duct 46, air is heated up to a predetermined temperature while it is being introduced from the external environment into the drum 44. That is, the heater 42 heats air, which is introduced under the suction force of the blower 31, before it is fed into the drum 44.

After introduced into the drum 44, air absorbs moisture from laundry and then flows to the exhaust passage 45 via the exhaust hole 43. Moisture-containing air is exhausted to the outer environment under the suction force of the blower 31, which is driven in response to the operation of the blower assembly 30. After flowing to the exhaust passage 45, air is exhausted to the outer environment via the exhaust duct 34. The suction force of the blower 31 allows the air to be exhausted from the drum 44 through the exhaust hole 43. The lint filter 36 purifies air passing through the exhaust hole 43 such that foreign particles (e.g. seam and fluff of laundry) contained in the air are not transferred into the blower assembly 30.

Meanwhile, the microcomputer 200 has a number of step values which are set up according to types of objects to be dried and the dryness thereof, and recognizes the dryness of a present object by comparing the value detected by the electrode sensor 38 with the step values. For example, the microcomputer 200 has five steps with respect to cotton stuff and a difference in temperature of respective steps is 1° C. Also, appropriate temperatures are set to the respective steps. Accordingly, if the detection value corresponds to the step 2, the microcomputer 200 recognizes the dryness of the object as being insufficient.

Therefore, the microcomputer 200 controls the heater 42 to continuously generate the heat Due to the heat generation of the heater 42 at the entrance of the feed duct 46, an external air introduced into the drum 44 via the feed duct 46 is heated up to a predetermined temperature and then fed into the drum 44.

The electrode sensor 38 is disposed at a portion of the exhaust hole 43 and detects the dryness of laundry loaded into the drum 44 while laundry is dried. The electrode sensor 38 detects a difference of voltages applied to both terminals of the electrode when the object is in contact with the electrode sensor 38, and provides the microcomputer 200 with a detected signal in the form of a voltage signal.

The detected value of the electrode sensor 38 is inputted into the microcomputer 200 via the electrode sensor signal conversion unit 202. The microcomputer 200 determines the dryness of laundry according to the change of the voltage value detected by the electrode sensor 38.

In addition, the microcomputer 200 detects the temperature of hot air, which is fed into the drum 44, using the first temperature sensor 48 and a signal detected by the first temperature sensor signal conversion unit 203, and detects the temperature of hot air; which is exhausted from the drum 44, using the temperature sensor 32 and a signal detected by the second temperature sensor signal conversion unit 204. In other words, the microcomputer 200 comprehensively judges the value detected by the electrode sensor 38 as well as the temperature of hot air introduced/exhausted into/from the drum 44 so as to determine the dryness of laundry. When the comprehensively judged value reaches a predetermined value, the microcomputer 200 cuts off the signal provided to the NPN transistor Q2 of the heater drive unit 208 to thereby stop the operation of the heater 42.

In addition to stopping the operation of the heater 42, the microcomputer 200 cuts off the blower drive signal, which the microcomputer 200 has been providing to the blower motor drive unit 207. The output of the normal operation detection unit 230 is also changed to a high signal. The output of the normal operation detection unit 230 detecting the rotation speed of the blower 31 to generate the control signal to the heater drive unit 208 is changed to a high signal. The PNP transistor Q1 of the heater drive unit 208 is switched to a turned-off state in response to the high signal.

As described above, since the two transistors Q1 and Q2 are all switched to the turned-off state, the heat generation of the heater 42 is stopped.

Summarily, this invention detects the rotation speed (RPM) of the blower 31 to monitor whether or not the blower 31 operates normally. Without regard to the control of the heater drive unit 208 by the microcomputer 200, it is determined whether or not the blower 31 operates normally. In other words, the microcomputer 200 can achieve double controls, i.e., the control of the heater 42 in a general case and the control of the heater 42 in case the blower 31 operates abnormally.

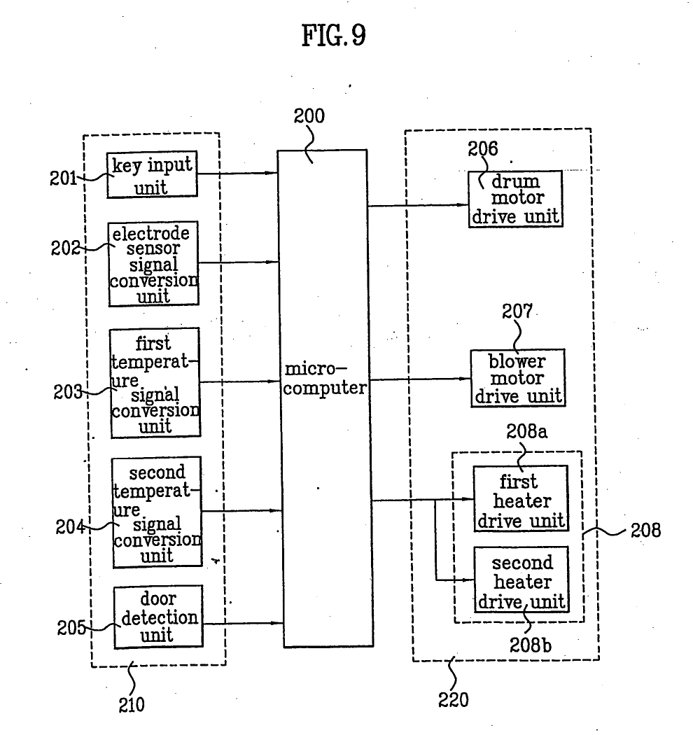

FIG. 9 is a construction of a drier in accordance with another embodiment of the present invention.

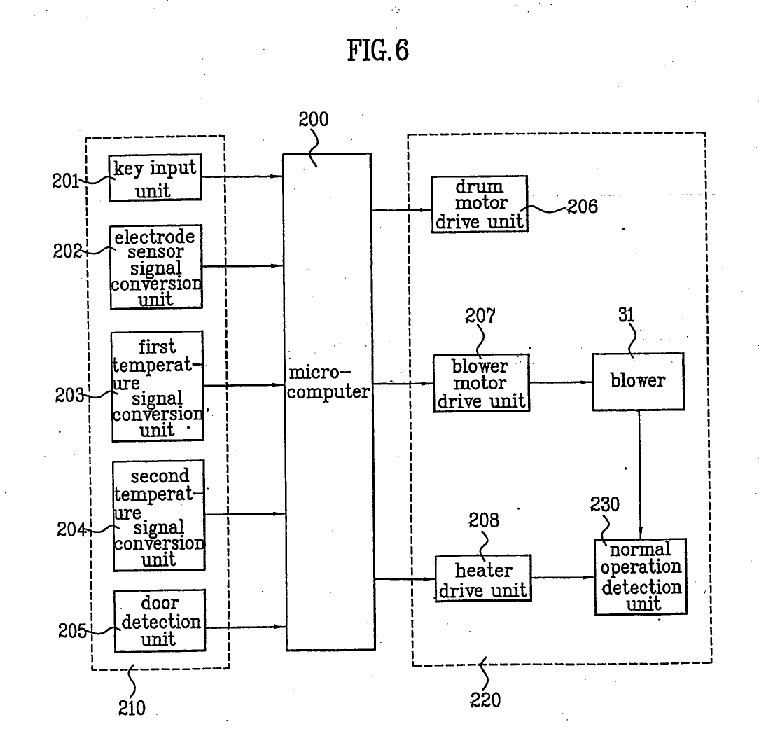

Referring to FIG. 9, the drier has a group of sensors 210 equal to that of FIG. 6 and a drive unit 220 different from that of FIG. 6.

The drive unit 220 includes: a drum motor drive unit 206 for driving a drum motor (not shown) which generates a driving force for rotating the drum 44; a blower motor drive unit 207 for generating a driving force for rotating the blower 31; and a plurality of heater drive units 208a and 208b for supplying a heat source for drying laundry via the feed duct 46.

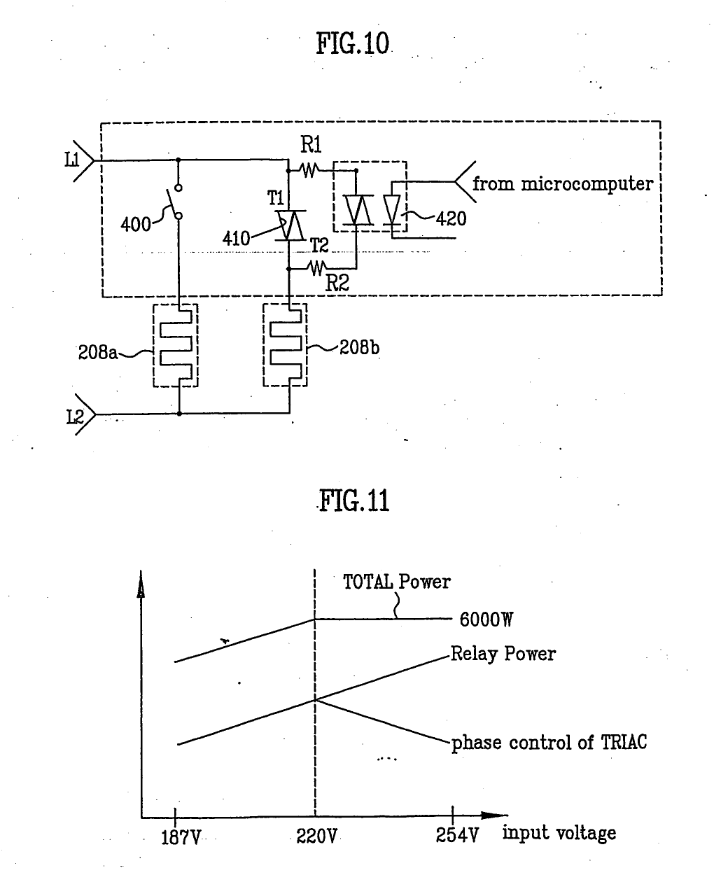

The heater drive units 208a and 208b in accordance with the another embodiment of the present invention are connected as shown in FIG. 10.

The heater drive units 208a and 208b are controlled by at least two relays 400 and triacs 410 which have large capacity, respectively. The on/off controls of the relay 400 and the triac 410 are accomplished by the microcomputer 200. In particular, an output of the triac 410 is controlled by a phase control and a photo-triac 420 is used to isolate a power supply between the triac 410 and the microcomputer 200.

Hereinafter, there will be described an operation of the drier of the present invention constructed as above.

A user primarily loads laundry into the drum 44 so as to dry laundry. The user closes a door and selects a dry mode from the key input unit 201. A selection signal corresponding to the dry mode is inputted into the microcomputer 200. The microcomputer 200 recognizes the dry mode of the drier in response to the selection signal and outputs a drum drive signal to the drum motor drive unit 206. As the drum motor is actuated, the drum drive belt 54 is rotated and accordingly the drum 44 is rotated.

Meanwhile, when the selection signal is inputted, the microcomputer 200 outputs a blower motor drive signal to the blower motor drive unit 207. The blower assembly 30 is operated in response to the blower motor drive signal and the operation of the blower motor assembly 30 drives the blower 31. If the blower 31 is driven, air in the drum 44 is exhausted to the exhaust duct 34 via the lint filter 36.

Before and after the time point when air in the drum 44 is exhausted, the microcomputer 200 outputs the heater drive signal to the heater drive units 208a and 208b. The microcomputer 200 determines an output power of the heater 42, which is necessary to output the heater drive signal. In other words, it is necessary to variably control the output power of the heater 42 according to the types of loaded objects to be dried and the dryness thereof.

Accordingly, the microcomputer 200 determines an amount of an electric energy of the heater 42 and causes one or both of the at least two heaters 208a and 208b to be operated One 208a of the heaters 208a and 208b generates a constant amount of the electric energy through the operation of the relay 400. The other heater 208b generates variable amounts of the electric energy according to a switching operation of the triac 410.

In other words, the microcomputer 200 controls the degree of the switching operation of the triac 410 through the photo-triac 420. An amount of the power supply voltage supplied to the heater 208b is controlled by the switching operation of the triac 410, so that the output power of the heater 208b is controlled.

FIG. 11 is a graph of the output power according to the operation states of the two heaters of the present invention.

Referring to FIG. 11, in case where at least two heaters 208a and 208b are simultaneously operated, the available output power is about 6000 W and it is possible to obtain a necessary thermal energy by controlling the phase of the triac 410 under the output power of below 3000 W. The output power of 3000 W to 6000 W can be obtained by controlling the phase of the triac 410 and simultaneously turning on the relay 400. In this manner, the control of the relay 400 and/or the triac 410 drives the heater 42 and also generates an appropriate amount of the thermal energy necessary for the drying operation.

While the loaded objects are being dried due to the thermal energy generated by the heaters 208a and 208b whose amount of electric energy is controlled, the microcomputer 200 determines the dryness of the objects according to the change of the voltages detected by the electrode sensor 38.

In addition, the microcomputer 200 detects the temperature of hot air, which is fed into the drum 44, using the first temperature sensor 48 and a signal detected by the first temperature sensor signal conversion unit 203, and detects the temperature of hot air, which is exhausted from the drum 44, using the temperature sensor 32 and a signal detected by the second temperature sensor signal conversion unit 204. In other words, the microcomputer 200 comprehensively judges the value detected by the electrode sensor 38 as well as the temperature of hot air introduced/exhausted into/from the drum 44 so as to determine the dryness of laundry. When the comprehensively judged value reaches a predetermined value, the microcomputer 200 stops the operation of the heaters 208a and 208b.

In addition to stopping the operation of the heater 42, the microcomputer 200 puts off the blower drive signal, which the microcomputer 200 has been providing to the blower motor drive unit 207. The blower drive signal is interrupted to cut off power toward the blower 31, thereby stopping the blower 31.

Industrial Applicability

This invention allows a heater to be operated while a blower is being rotated at a constant speed or above, so that it is possible to stably control a driving of the heater which generates a high thermal energy. In particular, by preventing a malfunction of the heater operated under the control of an electronic control device or a malfunction caused by external factors, breakdowns of the drier and damages on laundry can be prevented. Further, this invention can obtain an improved reliability through a stable driving of the drier.

In addition, this invention includes at least two heaters having large capacity. One heater generates a constant power using a device such as a relay and the remaining heaters variably control the outputs of the heaters using a power device such as a triac. Accordingly, a necessary thermal energy having a high power can be obtained by turning on the heater through the control of the relay and variably controlling the output power through the triac. As a result, an entire output power of the heaters can be variably controlled throughout a full range.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1-6. (canceled)

7. A drier comprising:
a drum rotatably mounted on the drier, for loading objects to be dried thereinto;
a heating means for heating air introduced into the drum; and
a control means for determining an amount of an electric energy to be supplied to the heating means according to the objects to be dried and controlling the heating means according to the determination result,
wherein the heating means includes:
at least two heaters independently generating heat according to a control of the control means; and
drive units for driving the heaters.

8. The drier of claim 7, wherein a first heater of at least two heaters generates the heat with a constant amount of the electric energy, and a second heater generates the heat with variable amounts of the electric energy.

9. The drier of claim 8, wherein the drive units include:
a first switching device for controlling the first heater to generate the heat with the constant amount of the electric energy; and
second switching devices for controlling the second heater to generate the heat with the variable amounts of the electric energy.

10. The drier of claim 9, wherein the first switching device is implemented with a relay.

11. The drier of claim 9, wherein any one of the second switching devices is provided with a triac, another is provided with a photo-triac for controlling a switching operation of the triac.

12. The drier of claim 11, wherein the photo-triac controls the switching operation of the triac according to a control of the control means, and the triac switches the second heater and a power source of the second heater according to a control of the photo-triac.

13-16. (canceled)

17. A drying control method of a drier, the drier including: a drum rotatably mounted on the drier, for loading objects to be dried thereinto; and a heating means for heating air introduced into the drum, the drying control method comprising the steps of:
determining an amount of an electric energy according to the objects to be dried; and
independently controlling a plurality of heaters according to the determination result, the plurality of heaters including the heating means.

18. The drying control method of claim 17, wherein the step of independently controlling the plurality of heaters is performed by controlling the plurality of heaters to generate a heat with a constant amount of an electric energy and/or variable amount of the electric energy.
